(19) United States
(12) Patent Application Publication
(10) Pub. No.: US 2021/0190576 A1
(43) Pub. Date: Jun. 24, 2021

(54) Device and Method for measuring the mass of a polarisable fluid in a container

(71) Applicants: JAMES BRADLEY, WARMINSTER, PA (US); ROBERT ANDREE EMIL GRIEBEL, WARMINSTER, PA (US); BERND STROETER, DEEP RIVER, CT (US)

(72) Inventors: JAMES BRADLEY, WARMINSTER, PA (US); ROBERT ANDREE EMIL GRIEBEL, WARMINSTER, PA (US); BERND STROETER, DEEP RIVER, CT (US)

(21) Appl. No.: 17/120,038

(22) Filed: Dec. 11, 2020

(30) Foreign Application Priority Data
Dec. 19, 2019 (DE) 10 2019 135 276.2

(51) Int. Cl. G01G 9/00; B25J 15/00

(52) U.S. Cl. CPC G01G 9/00; B25J 15/0019

(57) ABSTRACT

A method and a device for determining the amount of fill volume in a container. A mass of polarizable liquid in a container is positioned within the measurement region of a shielding antenna and a measuring pulse antenna. The shielding antenna is connected to both a measuring device that measures a time-dependent voltage value of an external interference signal and to a compensation signal generator that generates a time-dependent compensation signal compensating this interference signal. The measuring pulse antenna is connected to both a measuring pulse generator that generates a polarization signal to transmit to the fluid fill in the container and to a second measuring device that measures a response signal to derive the mass of the fluid from said response signal.

### BACKGROUND OF THE INVENTION

The invention relates to a device for measuring the fill content of fluid filling of a container. The present invention relates to a device and a method for measuring the mass of a polarisable fluid in a container.

The aim of the invention is to provide a method and a device for carrying out the method according to the invention, in particular when said containers are used in a greater number in receptacles of carrier plates and are to be controlled in a controlled manner in a metered manner. Devices and methods of this type are used, for example, in the medical field, where a greater number of container, combined in a nest, is to be precisely controlled with a medication fluid. One example of the invention is the production of disposable syringes, in which the syringes in nests are combined with a medication present as a liquid solution. Further examples of medical containers which, in comparison with disposable injection syringes, in each case attract other structural configurations of the associated nests, are vials and cylindrical ampoules.

In all cases, the amount of fluid introduced, that is to say the mass of the introduced fluid, must correspond to a predetermined target quantity (target mass) from the control of the comparability and to ensure the treatment success. In order to determine the quality, the application rate must be reduced at least in a random sample-like manner in order to determine the quality. In the case of mass production or production, such as is used for single-use syringes, vials or cylinder-type containers, this step should take the least amount of time in order to determine the amount of fill amount, two methods are used in the prior art.

On the one hand, it is usually possible in the case of the usual method by means of optical means, and then by multiplying by the cross-sectional surface and optionally adding a constant volume to the lower, non-cylindrical part of the syringe. As a result of further multiplication by means of a generally temperature-dependent, density, the quantity of fluid can be determined from this by means of further multiplication by means of a generally temperature-dependent density.

The disadvantage of this method is that the accuracy of the result is limited on the one hand by the accuracy, by means of which the fill height can be determined and, on the other hand, by the manufacturing accuracy of the syringe body, that is to say by the degree to which the actual cross-section of the syringe body deviates from the above described calculation. Even if the assumed value corresponds to the mean value of the cross section of many syringe bodies, that is to say there is no systematic deviation, there are still statistical deviations due to the manufacturing variance of the cross-sectional dimensions about this mean value. For simple mass-produced articles such as syringe bodies the deviations can be in the range of a several percent. In addition to this statistical effect there is a variance of the cross-sectional area along the syringe body which also leads to inaccuracies when determining the volume by multiplying the cross section by the fill height.

As a result of surface tension the surface of the fluid is also not flat, but displays a deformation at the contact line with the inner wall of the container, which can vary depending on the ingredients of the fluid as well as depending on potentially existing, surface tension modifying materials on the inner wall of the containers. This surface deformation can lead to inaccurate fill level measurements and in turn to inaccurate fill volume determination.

A further disadvantage is that the density of the liquid is only known to be approximated and, as a rule, also temperature sensitive, which requires the need of a precise temperature measurement. This increases the complexity and further reduces the accuracy of this first method for determining the fill volume.

The second method determines the fill volume by the weight of the filled syringe, as described, for example, in DE 10 200 4 035 061 A1. The filled syringe is weighed and the weight of an empty syringe is withdrawn. This method of determining the fill volume is then very precise, if the subtracted weight of the empty syringe is accurately known. This can be achieved in that the same syringe is weighed both before and after the filling. Nevertheless, in DE 10 200 4 025 061 A1, however, only the filled syringe is weighed and a standard weight of an empty syringe is not weighed. However, the actual weight varies as well as the cross-sectional area of the interior due to the production of syringe to syringe in the context of a certain tolerance of up to a few percent. The result obtained by this method is thus also affected by a corresponding error.

The object of the present invention is therefore to find a method and a device for determining the amount of fill volume, more precisely the fluid mass with the aid of which it is in the measuring process can be determined, without the result being influenced by the manufacturing inaccuracies of the containers.

### DETAILED DESCRIPTION OF THE INVENTION

This object is achieved according to the invention by means of a device according to claim 1, a plurality of said devices to be used by said devices according to claim 8 and a method of the assembly as claimed in claim 10.

In this case, use is made of the fact that the measuring fluids are largely composed of water at least in the medical region. Since the H2O molecules of the water have a strong dipole moment, water develops a strong polarization under the influence of an electric field when these dipole moments align along the outer field. At a given temperature and electric field, this polarity increases in proportion to the number of influenced water molecules, this in turn is proportional to the mass of the polarized fluid, the proportionality constant being given by the reciprocal of the s molar mass, which is a temperature-insensitive material-specific parameter.

If a polarisable liquid such as water is exposed to an electric alternating field, the dipoles of the molecules in their orientation basically follow the outer field, temperature dependent more or less rapidly, that is to say with a certain delay it makes it a time dependent variation of the polarization. However, the amplitude of the polarization is still proportional with respect to the number of dipoles, that is to say the amplitude continues to give rise to the mass of the polarisable fluid.

In the method according to the invention, to say in particular a syringe, vial or Linderampule (cartridge) is brought into the region of influence of a measuring pulse coil, in particular into the immediate vicinity, a flat or rod-shaped (dipole) antenna is positioned or inserted through the opening of a ring antenna. A measuring pulse generator now generates as a measurement pulse a time-dependent electrical field, for example an alternating field with a fixed frequency. This pulse is coupled in via the measuring pulse antenna into the polarisable fluid to be measured, in particular a liquid medium which can be polarised, wherein the response signal results in a time-dependent polarization of the fluid. This polarization response is the same from the outside with the measuring pulse antenna can be measured, since it receives the total field, that is to say the sum of the electric field of the measuring pulse and the polarization. In this case, the alternating magnetic fields which likewise occur here only indirectly interests the voltage or alternating fields, which are in particular induced of the ring antenna. The (time-dependent) polarization can be extracted from the signal received by the measurement pulse antenna by subtraction of the measurement signal and its amplitude can be determined from.

This results in the mass of the fluid which has contributed to the polarisation signal on the basis of a previously determined calibration gate. In this case, it is important to determine that even in the case of a ring antenna which, in geometrical terms, only forms a small part of the cylindrical container, or even in the case of a flat or rod-shaped antenna in direct proximity to the container, which does not completely surround the container in a geometrically u-shaped manner, but nevertheless picks up the entire surface of the liquid for polarization. This is due to the fact that the molecules further away from the antenna are less affected by the direct electrical field, but due to the polarization of the molecules closer to the antenna the electrical field from the ring antenna is amplified and this effect leads to the alignment of all dipoles which are in direct contact with one another align. This is the same principle as in the case of the transmission of magnetic flux in the iron core of a transformer. And, just as there, each air gap reduces the effect of the iron core of a transformer, the contact between the fluid components to be measured is essential here. This means that any fluid droplet of the method according to the invention or of the inventive method can be carried out at the edge of the container do not contribute to the response signal or hardly contribute to the response signal if they are not inconspicuous in the near proximity of the measuring pulse antenna and thus influence their direct influence. Therefore, it should be ensured, before the measurement, by suitable means, for example soft rattling to bring the fluid together.

The inventive method is characterized in that the volume forms a constant volume. If, in addition to the measuring pulse antenna, no further sources of alternating electrical fields exist, accurate results can be achieved only with the latter. However, now numerous further sources of electrical alternating fields, which are superimposed on the field generated by the measuring pulse antenna, and the measurement result can be found in a similar manner. On the one hand, a multiplicity of frequency and also natural like sources of electromagnetic radiation in particular the range between 10 and 100 kHz. These are, on the one hand, radio transmission (long-wave) as man made sources and the ionospheric oscillations of the sun. However, the remaining component of the interference signal does not stem from these far away and thus weak, but from the electrical apparatuses which are directly adjacent to the apparatus according to the invention, such as electric motors of conveyors or robot arms, relays and the like, which are inevitably present within the scope of the intended main application field of syringe filling and vial filling equipment. Depending on the class of electromagnetic compability of these devices they generate more or less strong emissions even in the (relatively) low-frequency range. More important, however, is the aspect that for the rapid simultaneous determination of the fill volumes of containers which are arranged in carrier plates or nests several invention related devices are used in parallel according to the invention. These signals, without further measures, would significantly interfere with each other unless measuring pulses with significantly different characteristics, such as frequency, timing, etc. are applied.

According to the second essential aspect of the present invention, the present invention provides an electromagnetic shield for the measuring pulse antenna. The latter could be designed as a passive shield, for example as a film made of a highly conductive material, for example a metal such as silver, copper, gold or, more particularly aluminum, which is bent to form a closed area, and thus forms a Faraday cage, in the interior of which the ring antenna is arranged. If the shielding film could be arranged as an entirely closed area a perfect Faraday cage would be given in case of a perfectly conductive film, and external interferences would thus be completely shielded off. Even considering limited conductivity excellent shielding would be achieved with an entirely closed geometry. However, because the object to be measured, that is to say the fluid flowing through the annular antenna, has to be conducted through the ring antenna, the shielding film does not have to be completely surrounded by the shielding film and all the rings can be completely surrounded by one another. In the shielding film, therefore, an opening must be provided as access to the interior. As a result of this opening, interfering fields can enter the interior with reduced but still significant strength. As a result, only a slight improvement of the measurement accuracy is achieved by means of a passive shielding film alone. In addition it is impossible to even partially enclose the containers in vials or syringe nests due to structural reasons.

In order to further increase the accuracy of measurement the current invention is suggesting an active compensation of external interference fields, that is to say an active shielding, by means of shielding antenna with connected electronics which allows for the compensation of external interference fields in a defined (measuring) range. In an embodiment of the present invention, which can be used for determining the concentration in syringe nests in disposable syringes, for example, the shielding film of a passive shielding is electrically connected to a sufficiently sensitive and above all fast voltage measuring device,

In particular, a voltage sensor is connected which measures the time-dependent voltage caused by outside interference electric fields. This information is called an alternating-voltage signal generator, also referred to as the shielding foil, within the scope of the invention, called compensation signal generator, The latter generates a magnetic field which is exposed to the magnetic field and conducts it to the shielding foil serving as a baffle, as a result of which a sufficient amount of field-free space is kept in the interior of the shielding foil.

In an alternative embodiment, which is also suitable for use as a vial and (cylinder) ampoule nests, a simple flat or rod-shaped shielding antenna is used, which is brought into proximity of the container to be measured, so that this container or at least the liquid contained therein, are located inside the measuring region defined by the shielding antenna. In this case, the measurement region is that space region around the shielding antenna, in which the active shielding by means of the compensation signal guarantees sufficient freedom of interference. In this case, the measuring pulse antenna is arranged in the measuring region between the shielding antenna and the container. In the context of the present invention it is not the main focus to reduce all frequency ranges of inference fields. It is sufficient to focus on frequencies which are similar to or smaller as the frequencies occurring in the measurement pulse emitted by the ring antenna. If frequencies in the range around 50 kHz are used, for example, a compensation of interference fields only in the region up to this frequency or slightly above this frequency is necessary for a sufficient improvement of the measurement accuracy.

Under the justified assumptions that the interference fields average out to zero and that the current measuring device for determination of the response signal of the polarized fluid is insensitive to frequencies above the measuring pulse frequency due to its sluggishness, the invention applies that the interference frequency is above this measurement range, the less influences the measurement result. Accordingly, the lower the need to actively compensate for them. In the above example, approximately interference signals with frequencies of significantly above 50 kHz is of little relevance to the measurement of the amplitude of the response signal. As a result, the reaction time Dt of the active shielding In the form of the described feedback voltmeter and compensating signal generator need not be significantly better than the reaction time of the current measuring device detection of the polarization signal. In this case, the time offset means between measurement of a specific interference signal level by the voltage sensor at a time t and the application of the compensation signal generated thereupon at the time t+Dt. The reaction time of the active depletion does not have to be substantially better than 100 microseconds in the response signal only at most as far as the range of, for example, 100 microseconds. Circa 50 microseconds, in this example, is well sufficient.

A device which can be used to implement the method according to the invention comprises a ring antenna which is arranged in the interior of a shield, in particular in the form of a film made of conductive material. With the exception of an O-opening for charging the containers to be measured, such as, for example, syringes. A signal generator, which is called a measuring pulse generator and generates an excitation signal, is connected to the ring antenna in such a way that the content is polarised by means of the ring antenna to be measured is coupled in. The invented device senses the response in the form of a time-dependent polarization signal antenna, and derives the total polarization of the sample from the measured signal, more precisely from the field amplitude. This signal in turn can be converted into the desired fill volume using a proportionality factor which has been predetermined by means of a calibration. For this purpose, corresponding control electronics can be present, which automatically carry out these steps. This is particularly advantageous for practical use, since it makes it possible for the measurement to be sped up. The principle of the present invention is not essential to an automated evaluation, but can also be carried out by a human being. The application case, which is particularly considered here, is the measuring of the fill contents of (disposable) syringes, vials or ampules.

The method according to the invention and the device according to the invention can, however, be used in exactly the same way as the determination of the size of other containers as long as the latter are inserted from their shape and their dimensions into the O-opening of the ring antenna and can be combined with a polarizable liquid carrier. Ethanol, methanol and isopropyl alcohol are likewise very highly polarizable fluids, ie those with strongly polar molecules.

The invention further relates to further advantageous embodiments of the invention, which can be combined with one another in a suitable form, provided that they are not mutually exclusive. The shielding film preferably forms a substantially cylindrical, in particular substantially cylindrical, co-extrusion, since this shape is well adapted to the container or cylindrical containers to be coated, in particular injection-molded products.

The opening for the insertion of the containers is located on an end face, particularly preferably an upper face side, of this cylindrical or cylindrical shape.

The ring antenna is preferably arranged in an upper region of the shield, that is to say rather close to the O-opening, in order to adjust a fill measurement to enable even in the case of containers, in particular syringes, which protrude only slightly from their carrier plate, wherein the term close ‘ is preferably arranged in an upper region of the shield, that is to say rather close to the O-opening, wherein the term close’ is determined by comparison with the characteristic size of the order to be measured is to be understood. However, this will be of a regular design of the same order of magnitude as the filling process itself, since the size of the measuring device according to the invention can be adapted to the size of the order to be measured there, depending on the field of use. The ring antenna is preferably designed as a single-line coil, since this brings about the minimal space requirement.

Since the shielding foil does not need a large wall thickness, according to the invention, it is preferable to have a film made of a highly conductive material, in particular metal such as gold, copper, aluminium or, ideally, silver. In order to mechanically stabilize it in practical use, it is proposed that this shielding foil has a supportive structure, for example a plastic cylinder or cylinder skeleton. In order to accommodate the electronics connected to the shielding film and the ring antenna, a structure is preferably used, in particular an approximately quasi-rectangular structure or a structure having three, four or hexagonal cross-sections. By the latter, is achieved in that, when a plurality of devices are combined to form an arrangement according to the invention according to claim 8, the devices can be arranged in a regular triangle or hexagonal grid, which advantageously corresponds to the u-shaped arrangement of the receptacles in support plates. The composite material is basically arbitrary, as long as it has a sufficient mechanical load-bearing capacity. Plastic, metal or wood, for example, are suitable. The latter can be connected to the supporting structure of the shielding foil, ie the structure is arranged on an outer side of the housing.

The invention is characterized in that structures are placed on and placed in a detachable manner or in such a way that they can be connected, for example by screws, rivets, adhesive bonding or welding. An alternative embodiment of the present invention conceals a shielding as well as a measuring pulse antenna in each case a flat antenna or rod-shaped antenna which is arranged at a short distance from one another, which are arranged parallel to one another. For example, they can be applied to opposite sides of a panel which is transparent in the corresponding frequency range, for example of plastic or wood. This plate can be in the device according to the invention can be integrated into the device according to the invention, or can be fastened thereto separately from the outside.

The measuring device is designed to measure the polarization response signal by preamplifier. In some embodiments of the present invention, even weak response signals still encompass good response signals in some embodiments of the present invention. It is to be understood that the invention is not limited to the embodiments described above, but it is to be understood that the invention is. The latter is preferably an operational amplifier, which is connected to the measuring pulse antenna with an inverted input.

The device according to the invention can be attached to a robot arm which, in order to measure the fill contents from below, has the following-According to the invention, a plurality of devices according to the invention are used in an application device in order to simultaneously use a plurality of devices according to the invention, two or more dimensions are measured. To this end, the inventive devices, or at least the shields with an internal ring antenna, are arranged at a distance from the recesses in the support plates. In the extreme case, just as many devices such as recesses can be present in the carrier plate, as a result of which the fill can be used to common all of the employed containers at the same time as the fill contents. The reaction time of the active shield, that is to say the time offset between the measured interference signal level and the compensation signal, is preferably in the range of the time offset of the current measuring device. In particular, the reaction time should be less than 100 microseconds, particularly preferably less than 50 microseconds. The measuring devices used can comprise a preamplifier in the form of an operational amplifier, which is preferably operated with an inverted input. The compensation signal generated by the compensation signal generator preferably has a bias, ie a fixed bias. This ensures that the voltages move exclusively in a region above or below the zero line.

For the polarisation generator made polarizing signal. Different pulse forms come into consideration. On the one hand, a said voltage pulse having a temporal extension that is greater than the temporal placement of the current measuring device used to detect the response signal, in particular a pulse having a duration in the range of 100 microseconds to 1 millisecond. Furthermore, an alternating voltage of constant frequency can also be of a certain time duration which is large counter to the temporal charging of the current measuring device, in particular approximately 10 to 1000 milliseconds. The frequency of the alternating voltage should be selected in such a way that the pulse duration comprises at least some periods, in particular in the range from 1 to 100 kHz, particularly preferably 40 to 50 kHz. Further properties, features and advantages of the present invention result from the exemplary embodiments explained below with reference to FIGS. 1,2,3 and 4. The present invention is intended to be illustrative only and is not intended to be limiting in any way.

### BRIEF DESCRIPTION OF THE DRAWINGS

FIG. 1: A preferred embodiment of a measuring device according to the invention in cut-away or specular view

FIG. 2: The electrical circuit diagram of the embodiment of FIG. 1

FIG. 3: The invention also relates to an arrangement according to the invention, which is used for the simultaneous measurement of a plurality of syringes

FIG. 4: A schematic section through a second preferred embodiment of the present invention is the use with vials or ampules.

A measuring device according to the invention is shown in FIG. 1 in a partially cut-away perspective representation. In this embodiment, the device according to the invention consists of the three parts shield 2, ring antenna 30 and the housing 4, which houses the electronics. Shield 2 around the cylindrical shielding foil 29, which is also used as a shielding antenna, surrounds the cylindrical shielding foil 29, which also serves as a shielding antenna, and is mechanically stabilized by the shielding structure 28. The upper end face of both the structure 28 and the shielding foil 29 is open and forms the circuit boundary O-opening through which the operating medium 100 to be measured is divided into the inner-space of the shield 2. The interior also simultaneously represents the measurement region 20. In the upper region of the interior 20 of the shield 2, the ring antenna 30 of the type is arranged, which lies on the cylinder axis of the shield 2 in its normal position. The ring antenna 30 is connected to the measuring electronics 3 is connected in a circuit-related manner in the housing 4. The measuring electronic unit 3 comprises a measuring pulse generator 32 and a second voltage measuring device 31. The measuring pulse generator 32 is a signal generator which is used to polarize the fluid volume of the container 100 to be measured.

The electronic system used for active shielding is also accommodated in the housing 4 and comprises the first voltage measuring device 21 and the compensation signal generator 22. The housing 4 has a cross-section in the form of a regular hexagon, which has the advantage that, when a plurality of devices according to the invention are connected to form an arrangement according to the invention, a regular hexagonal grid can be generated. This corresponds to the pattern in which the receptacles in carrier plates, also called nests, are usually arranged.

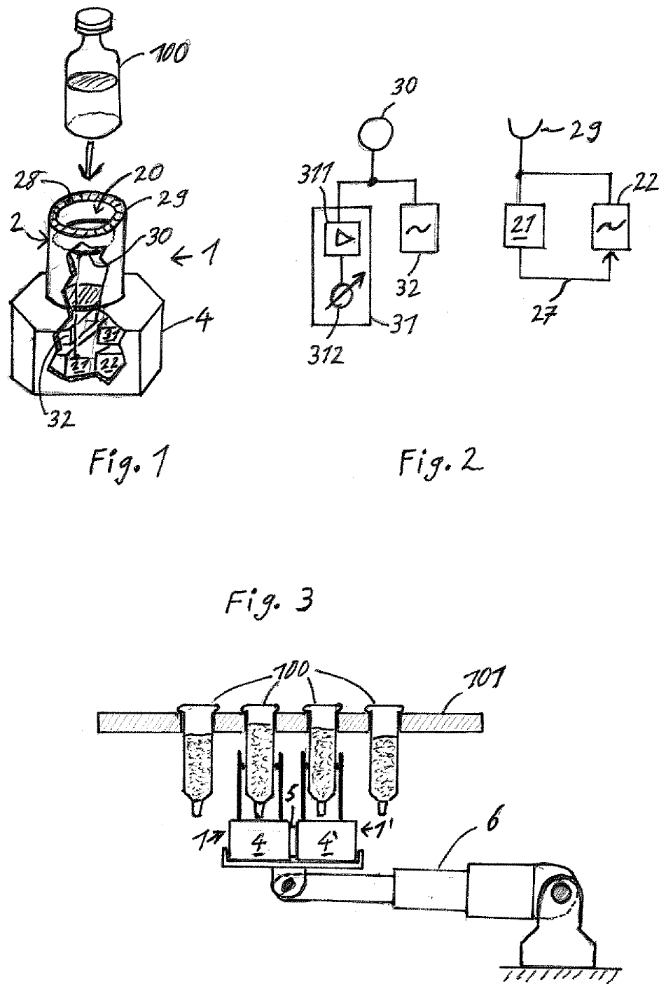

FIG. 2 shows the circuit diagram of the electronic components used in the embodiment of FIG. 1 for use. The second voltage measuring device 31 and, on the other hand, the measuring pulse generator 32 are connected to the ring antenna 30 serving to couple the measuring signal into the sample. The measurement pulse generator 32 generates the current required to polarize the fluid signal in order to be measured in the form of a voltage pulse, which can be, for example, Gaussian, Lorentz, or Heavyside—Step Form, or can also take the form of an AC voltage signal having a fixed frequency, which AC voltage signal is emitted for a certain period of time. The polarization signal generated in order to be measured is recorded by means of the same ring antenna 30 and is evaluated on the voltage measurement unit 31, which is likewise connected to the ring antenna 30, consisting of the preamplifier 311 and voltmeter 312.

The active shield is used for largely eliminating the components of the fluid sample which penetrate through the O-opening 20 of the shield into the interior of the shield and do not influence the parts of the fluid sample which are not located in the interior of the shield, in addition to the measuring process described above. It comprises 30 the shielding foil 29, which also functions as an antenna, voltage sensor 21 and compensation signal generator 22, the latter are connected to one another by means of a coupling 27. The chip sensor 21 detects the current interference signal level present on the shielding film 29 in the opposite direction to a reference level, for example the earth. The measured signal to the compensation signal generator 22, which thereupon generates an oppositely directed signal which is delayed in time and, with a certain pre-voltage, conducts it to the shielding antenna 29 in order to compensate for the interference signal and to transmit into the interior space and the fluid in order to be measured free of interference signals.

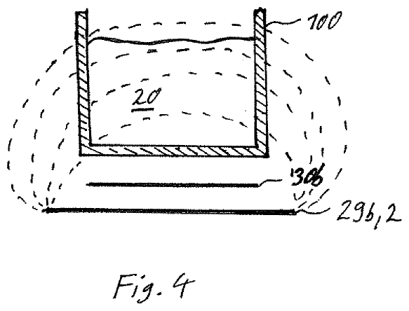

FIG. 3 illustrates an arrangement according to the invention in use in the simultaneous fill volume determination of a plurality of containers, here syringes. As shown, two devices 1, 1′ are connected to each other at a distance from one another by means of their respective housings 4, 4′ in such a way that their distance corresponds to the two fluid containers to be measured, here container 100, inserted into carrier plate 101. For this purpose, a spacer 5 is arranged between the housing 4, 4′ the arrangement created in this way is mounted on a multi-axis robot arm 6, shown only schematically, which can move it and pivot it in one or more axis in order, as shown, to push the syringes 100 projecting downwards out of their support plate 101, as shown. Thanks to the active shield can then be used to measure the fluid in two syringes 100 at the same time, without the measurement being of opposite to influence.

Since it does not allow the structural conditions in the case of vials or ampules, it is not possible to introduce the containers held in the nest, that is to say vials or ampules, into the interior of a hollow-cylindrical shielding of the outer casing of FIG. 1, according to the present invention, such nest has a different configuration, which is shown in a schematic section in FIG. 4.

In this embodiment, the active shield 2 comprises the flat or rod shaped shielding antenna 29b, as well as the compensation electronics (not shown) connected thereto. The polarizable fluid to be measured in the container 100 is completely located within the measuring region 20, in which the compensation field generated by the shielding antenna 29b (dashed - indicates) a more efficient time-dependent interference electric fields. The size of this region corresponds approximately to the width of the shielding antenna 29b and the width of the shielding antenna 29b, which is why this size is hollowed as the width or diameter of the container 100. The likewise flat or rod shaped measuring pulse antenna 30b, to which the measuring electronics (also not shown) are connected, is arranged parallel to the shielding antenna 29b, aligned between the latter and the housing 100. In this case, the measuring pulse antenna 30b should be brought into close proximity to the operating element 100 in order to generate the signal strength. In order that the measuring pulse antenna 30b lies completely in the measuring range at the same time, it is dimensioned to be smaller than the shielding antenna 29b.

### LIST OF REFERENCE CHARACTERS

1 Set-up
2 (active) Shield
20 Measurement region
21 First voltage measuring device
22 Alternating voltage generator
28 Structure
29 Shielding film, hollow-cylindrical shielding antenna
29b Flat or rod-shaped shielding antenna
30 Ring-shaped measuring pulse antenna
30b Flat or rod-shaped measurement pulse antenna device
31 Second voltage measuring
311 Amplifier
312 Voltmeter
32 Measuring pulse generator
4 Housing
5 Spacer
6 Robot arm
100 Container, syringe
101 Carrier plate

1. The invention relates to a device for measuring a mass of a polarisable fluid in a container (100)
a shielding antenna (29, 29b), which defines a measurement region (20), of an active shield (2), wherein the shielding antenna (29, 29b) is connected to a first measurement device (21) and a compensation signal generator (22),
a measuring pulse antenna (30, 30b) which is connected to a second measuring device (31) and a measuring pulse generator (32) and is arranged within the measuring region (20), and wherein the device is prepared for this purpose by means of the first measuring device (21), to measure a time-related voltage value of an external interference signal and to generate a compensation signal compensating this interference signal by means of the compensation signal generator (22) and to conduct said compensation signal to the shielding antenna (29, 29b) and thus to achieve a wide range of accuracy of the measurement range (20), and to generate a polarisation signal by means of the measuring pulse generator (32) and to polarize the measuring pulse antenna (30,30b) by means of the measuring pulse generator (32) and to measure a response signal by means of the second measuring device (31) and to derive the mass of the fluid from said response signal.

2. Device according to claim 1, characterized in that
the shielding antenna (2) is a hollow-cylindrical antenna (29), in particular made of thin conducting film, which is open at one end, in particular an upper end, in order to cover at least partial insertion of the container (100) into an inner space of the hollow cylindrical antenna (29), and
the measuring pulse antenna is a ring antenna (30), which is arranged in such a way that an operating medium (100) introduced at least partially, passes through the ring antenna (30).

3. The invention relates to a device according to one of claims 1 or 2, characterized in that the hollow-cylindrical shielding antenna (29) is formed from the inside by a supporting structure (28), in particular a non-conductive and non-magnetic supporting structure in the form of a cylinder or cylinder skeleton made of plastic.

4. Device according to one of claim 3, characterized in that the supporting structure (28) is mounted with a shielding antenna (29) and ring antenna (30) on a housing (4), in particular in an approximately quasi-rectangular housing or a housing having a three-or hexagonal cross-section, in which the measuring and shielding electronics, ie the first measuring direction (21), the compensation signal generator (22), the second measuring device (31) and the measuring pulse generator (32) are provided.

5. Device according to claim 1, characterized in that the shielding antenna (29b) and the measuring pulse antenna (30b) are arranged next to one another in a row at a small distance from one another in a row in comparison with a line of the shielding antenna (29b).

6. The device according to one of claims 1-5, characterized in that the second measuring device (31) comprises a voltmeter (312) which is connected in parallel to a preamplifier (311).

7. Device according to claim 6, characterized in that the preamplifier is an operational amplifier which is operated with inverted input.

8. The invention relates to an arrangement comprising a plurality of devices common to one of the devices 1-7 for measuring the fluid in a plurality of containers having a polarisable fluid, said containers being inserted into receptacles of a carrier plate, and at least partially protruding through the carrier plate, characterized in that the devices are arranged at a distance from one another and in a manner such that they can be moved together in such a way that at least two, preferably all, of the containers can be introduced into the measuring regions of two, preferably all, of the devices in an identical manner.

9. Arrangement according to claim 8, characterized in that the devices are fastened to a multi-axis robot arm and can be moved together by means of said arm.

10. The invention relates to a method for determining a mass of a polarisable fluid of a combined container (100), characterised in that
a) At least far into the measurement region (20) of an active shield (2) defined by a shielding antenna (29, 29b), in such a way that the fluid is completely or largely located in the measuring region (20),
b) The measurement of the fluid mass is then carried out in-which is measured by means of a measuring pulse antenna (30, 30B) one of which is connected to the measurement pulse antenna (30, 30B) coupled measurement pulse generator (32), to the fluid in the interior of the container (100) and is thereby polarised, and by means of a control device which is likewise connected to the measuring pulse antenna (30, 30B), a response signal of the polarised fluid is measured and the fluid sample is derived there from,
c) wherein a time-delay compensation signal is measured by means of a first measuring device (21) connected to the end-of-coil measuring device and a compensation signal that compensates for the interference signal is generated on the basis of the measured interference signal by means of an alternating voltage generator (22) and is conducted to the shielding antenna (29. 29b) in order to ensure the freedom of interference of the measuring region (20).

11. Method according to claim 10, characterized by a reaction time of the active shielding of less than 1 millisecond, preferably less than 100 microseconds.

12. Method according to one of the claims 10-11, characterized in that the second measuring device (31) is connected to the measuring pulse antenna (30,30b) in the form of an operational amplifier (311) as a pre-amplifier, and in particular comprises a voltmeter (312).

13. The method according to one of claims 10-12, characterized in that the polarization signal generated by the measurement pulse generator (32)
a voltage pulse, in particular a DC voltage pulse or an alternating voltage pulse having a Gaussian envelope, or
an alternating voltage of constant amplitude and frequency, and/or
a frequency between 10 and 100 kHz, preferably 40 to 50 kHz.

14. The method according to one of claims 10-13, characterized in that the compensation signal generated by the compensation signal generator (22) has a bias voltage, in particular in the range of 0.1-10 volts
